(19) United States
(12) Patent Application Publication
(10) Pub. No.: US 2005/0252791 A1
(43) Pub. Date: Nov. 17, 2005

(54) Removal of hydrogen from coolant fluid

(76) Inventors: Rainer Pechtold, Russelsheim (DE); Thorsten Rohwer, Trebur (DE)

Correspondence Address: HARNESS, DICKEY & PIERCE, P.L.C., P.O. BOX 828, BLOOMFIELD HILLS, MI, 48303, US

(21) Appl. No.: 10/843,013

(22) Filed: May 11, 2004

(51) Int. Cl. A45C 13/10; A45C 13/18; H01M 8/00

(52) U.S. Cl. 206/1.5

(57) ABSTRACT

A coolant reservoir for use in a coolant system of a fuel cell stack is provided, and includes a catalyst element disposed in the vessel and being capable of reacting hydrogen within the vessel with oxygen from outside air. The catalyst element includes a heating system for heating the catalyst element to a predetermined temperature.

### FIELD OF THE INVENTION

The present invention relates to the cooling of a fuel cell stack, and more particularly, to the removal of hydrogen from coolant fluid used in cooling a fuel cell stack.

### BACKGROUND AND SUMMARY OF THE INVENTION

A fuel cell stack typically uses a membrane electrode assembly (MEA) that is sandwiched between bipolar plates that define anode and cathode passages which communicate with opposite sides of the MEA. The bipolar plates are provided with coolant passages therethrough for cooling the fuel cell stack and maintaining it at a desired operating temperature. The coolant is circulated from a reservoir through the coolant passages provided in the bipolar plates and is returned to the coolant reservoir. As is known in the art, a heat exchanger can be utilized for removing heat from the coolant after the coolant has passed through the fuel cell stack. The anode gas of a fuel cell stack is typically hydrogen. A small quantity of hydrogen is always present in the fluid of the coolant circuit. Hydrogen can enter or penetrate the coolant fluid if the sealing of hydrogen in the system is not 100 percent. In addition, as the coolant flows through the electrical field of the fuel cell, water within the coolant may be split into oxygen and hydrogen through electrolysis. This phenomenon can be reduced by selecting a coolant fluid with appropriate properties, but cannot be entirely eliminated. Like all gas bubbles, the hydrogen that is present in a coolant fluid will gather, over time, in the reservoir container. The accumulation of hydrogen within the container is undesirable and, therefore, needs to be removed.

Various solutions have been suggested, including one variant to install a blower in the reservoir accumulation container to constantly replace the gas within the coolant reservoir. This configuration is shown in FIG. 4 which represents the prior art. With the system shown, the blower 100 forces filtered air through the coolant reservoir 102 which then carries the accumulated hydrogen out of the reservoir and can be released to the ambient air or otherwise processed. This type of arrangement requires the use of an additional blower as well as electric power used to drive the blower and is, therefore, a significant added expense. Other disadvantages of the arrangement are that some amount of coolant will be lost with the constant circulation of air into and out of the coolant reservoir. With the constant loss of coolant, it then becomes necessary to frequently refill the coolant fluid. Furthermore, the blower 100 creates a noise problem that would need to be quieted. The noise problem would be particularly noticeable since the blower must be operated for some time after vehicle shutdown has been completed.

According to the principles of the present invention, a coolant reservoir is provided with a catalyst element disposed in the vessel wherein the catalyst element is capable of reacting hydrogen within the vessel with oxygen from outside air. The catalyst element includes a heating system for heating the catalyst element at a steady temperature. The temperature of the element is preferably high enough so that water droplets, forming by the combination of oxygen and hydrogen, striking the surface of the element would evaporate immediately. According to another aspect of the present invention, the catalyst element is provided with a protective layer or splash guard to prevent coolant from contacting the catalyst element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of a coolant reservoir having a catalyst element disposed in the vessel for reacting hydrogen within the vessel with oxygen from outside air according to the principles of the present invention;

FIG. 2 is a schematic illustration of a coolant reservoir provided with a heated catalyst element having a splash guard schematically illustrated;

FIG. 3 is a detailed schematic illustration of the heated catalyst element with a porous protective layer according to the principles of the present invention;

FIG. 4 is a schematic illustration of a prior art method of removing hydrogen from a coolant reservoir;

### DETAILED DESCRIPTION OF THE PREFERRED EMBODIMENTS

The following description of the preferred embodiment(s) is merely exemplary in nature and is in no way intended to limit the invention, its application, or uses.

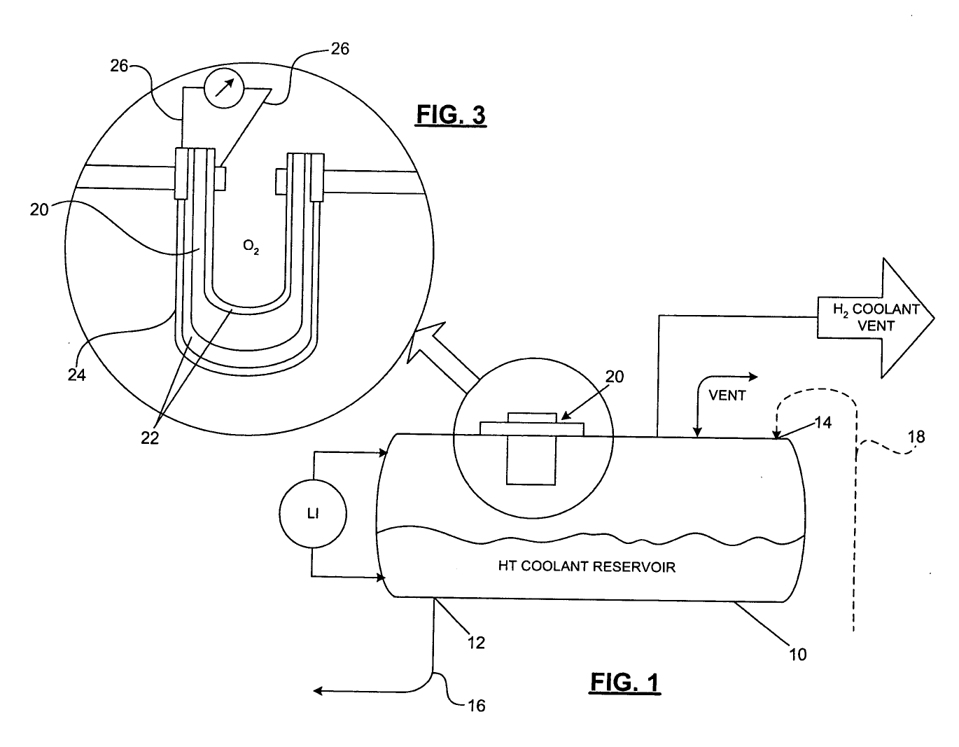

With reference to FIGS. 1-3, the system for removing hydrogen from a coolant reservoir according to the principles of the present invention, will now be described.

As shown in FIG. 1, a coolant reservoir 10 is provided and includes an amount of coolant therein. An outlet port 12 and inlet port 14 are provided for allowing coolant from the reservoir 10 to be pumped from the coolant reservoir 10 through a coolant system for a fuel cell stack and returned to the coolant reservoir 10 via the inlet port 14. A coolant outlet passage 16 is connected to the outlet port while a coolant inlet passage 18 is connected to the inlet port 14.

A catalyst element 20 is installed in the coolant reservoir. The catalyst element 20 is based on the Lambda-Sensor technology, which is state of the art for internal combustion engines. The catalyst element 20 consists of a ceramic element that is usually made of Zirconiumdioxide, acting as an electrolyte. Oxigen-ions can pass this ceramic element 20 if it has as certain minimum temperature. Therefore, a heating unit is integrated in the ceramic element 20. It operates like a PTC (Positive Temperature Coefficient) element to prevent overheating. If the temperature increases, the electrical resistance increases and the current decreases resulting in a reduction of heating. Properly dimensioned, the heating element creates a self-regulating temperature. In the suggested application, the power of the heating element may have to be readjusted. The direction in which oxigen-ions will pass through the ceramic element 20 depends on the difference of concentration (partial-pressure-difference) of the oxygen. As one side is exposed to the ambient air and one to the inside of the reservoir, the direction will be from the ambient to the inside, because the oxygen concentration is higher in the ambient air.

The ceramic element 20 is coated inside and outside with catalytic material, usually platinum 22. On the outside, oxygen-ions and electrons are created from the oxygen of the ambient air. On the inside, the oxygen-ions and electrons react with the hydrogen. The shape of the ceramic element 20 and the amount of catalytic material may have to be specially designed for the suggested application. The catalytic coating also acts as electrodes. If the outer and inner electrodes are connected, the electrons can flow from the outside to the inside, allowing the reaction with hydrogen. This flow of electrons can be measured as a current if the contact is made through the wires 26 and the sensor-electronics. In the suggested application, it is not necessary to measure this current. A simple shortcut would be sufficient, but it may be desirable to measure the current as a fault-detection. As long as current can be measured, the reaction takes place, and the catalyst is functioning properly. The inner surface is usually protected by a porous ceramic layer 24.

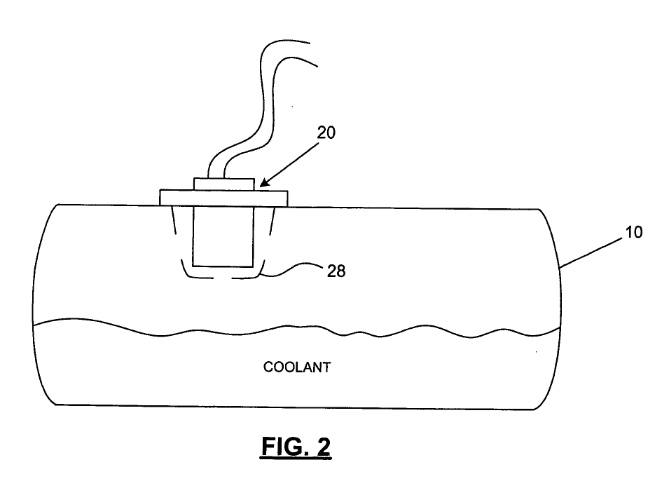

If the system of the present invention is used on a moving vehicle or under other conditions where coolant may reach or be splashed onto the catalyst element 20, a splash guard 28, such as illustrated in FIG. 2, can be utilized. The splash guard 28 is preferably a thin sheet metal part with holes, as illustrated in FIG. 3, in which the heated catalyst unit 20 includes the ceramic body 20 with integrated heating element which is provided with catalytic coating 22 surrounding the ceramic catalyst element 20. The porous protective layer 24 surrounds the ceramic catalyst element 20 and mechanically protects the catalytic coating 22. It also prevents small amounts of coolant from splashing on the catalyst element 20 while still permitting the passage of gas including hydrogen therethrough so as to contact the catalyst element 20.

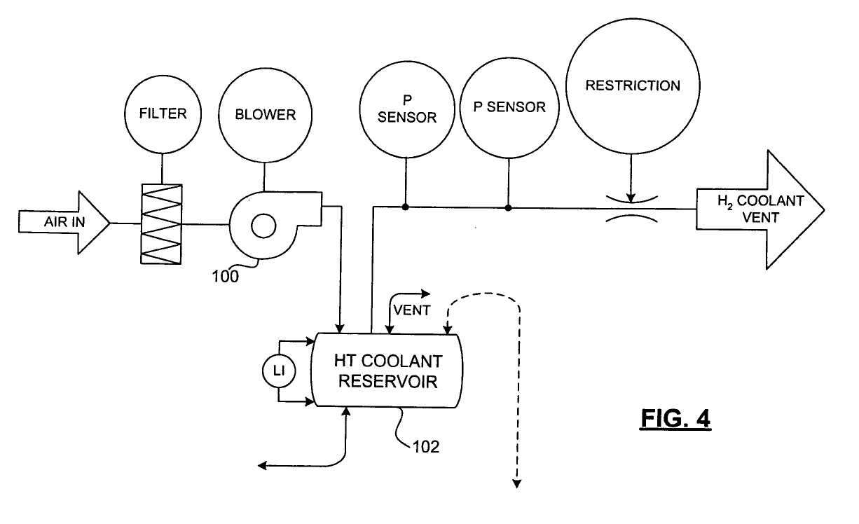

With the system of the present invention, the accumulation of hydrogen within the coolant reservoir can be prevented and the hydrogen dispersed while preventing a reduction in the number of components and their associated cost as compared to the prior art system illustrated in FIG. 4. Furthermore, with the system of the present invention, there is no blower noise, no hydrogen is released to the atmosphere, and there is no coolant loss due to the system of the present invention. With the system of the present invention, the hydrogen reacts with the oxygen to become water and becomes part of the coolant.

The description of the invention is merely exemplary in nature and, thus, variations that do not depart from the gist of the invention are intended to be within the scope of the invention. Such variations are not to be regarded as a departure from the spirit and scope of the invention.

1. A coolant reservoir, comprising:
a vessel having an inlet port and an outlet port adapted to be connected to inlet coolant and outlet coolant passages, respectively, of a coolant system;
a catalyst element disposed in said vessel, said catalyst element being capable of reacting hydrogen within said vessel with oxygen from outside air.

2. The coolant reservoir according to claim 1, wherein said catalyst element includes a heating system for heating the catalyst element.

3. The coolant reservoir according to claim 2, wherein said heating system includes an electrical resistive heater.

4. The coolant reservoir according to claim 1, further comprising a guard element around said catalyst element to prevent coolant from contacting said catalyst element.

5. The coolant reservoir according to claim 4, wherein said guard element includes a porous protective layer surrounding said catalyst element.

6. The coolant reservoir according to claim 1, wherein said catalyst element is an electrolyte coated ceramic.
